(19) United States
(12) Patent Application Publication
(10) Pub. No.: US 2023/0406397 A1
(43) Pub. Date: Dec. 21, 2023

(54) LINEAR ACTUATOR AND STEERING SYSTEM

(71) Applicant: Ewellix AB, Göteborg (SE)

(72) Inventor: Bernd Spigaht, Liestal (CH)

(21) Appl. No.: 18/334,513

(22) Filed: Jun. 14, 2023

(30) Foreign Application Priority Data
Jun. 21, 2022 (DE) 10 2022 115 460.2

(51) Int. Cl. B62D 3/02; B62D 7/20; F16H 25/20

(52) U.S. Cl. CPC B62D 3/02; B62D 7/20; F16H 25/2015; B62D 5/0421

(57) ABSTRACT

A linear actuator includes a housing and a linear unit disposed in the housing. A spindle of the linear unit, which is in particular axially displaceable in the housing, is radially supported at its two axial ends on the housing. A steering system or a double-pivot steering system with the linear actuator is also provided.

### CROSS-REFERENCE TO RELATED APPLICATION

This application claims the priority, under 35 U.S.C. § 119, of German Patent Application DE 10 2022 115 460.2, filed Jun. 21, 2022; the prior application is herewith incorporated by reference in its entirety.

### FIELD AND BACKGROUND OF THE INVENTION

The present invention relates to a linear actuator and a steering system.

Linear movements, e.g. for actuating machine parts, can be generated by using linear actuators. Such linear actuators may for example include a linear unit which converts a rotational movement of a motor shaft into a translational movement. Another known configuration of a linear actuator is a hydraulic cylinder.

Electromechanical linear actuators having a linear unit are advantageous in comparison with hydraulic cylinders, amongst others with respect to their efficiency, stiffness and positionability. In addition, they can be operated without hydraulic fluid or oil. However, the linear unit takes up a certain amount of installation space, so that linear actuators with a linear unit usually have a poorer ratio of total length to travel (or travel-length ratio) than hydraulic cylinders. Therefore, hydraulic cylinders used in applications in which installation space is critical, e.g. vehicles such as forklift trucks, tractors and aircraft tugs, lifting platforms or personnel lifts, agricultural machines or other mobile applications, cannot be replaced by electromechanical linear actuators.

### SUMMARY OF THE INVENTION

It is accordingly an object of the invention to provide an improved linear actuator with a linear unit and an improved steering system, which overcome the hereinafore-mentioned disadvantages of the heretofore-known devices of this general type, in particular a compact linear actuator and a compact steering system with a large travel.

This object is achieved by a linear actuator and a steering system according to the independent claims.

Preferred embodiments are the subject of the dependent claims and the description which follows.

With the foregoing and other objects in view there is provided, in accordance with a first aspect of the invention, a linear actuator, in particular for a steering system, having a housing and a linear unit disposed in the housing. According to the invention, a spindle of the linear unit, which is in particular axially displaceable in the housing, is radially supported on the housing at its two axial ends.

One aspect of the invention is based on the approach of configuring a spindle of a linear unit in such a way that upon an axial movement, the spindle can be supported radially on a housing of a corresponding linear actuator. In particular, the housing may be configured to guide the axial movement of the spindle and absorb any transverse loads which could reduce the service life of the linear unit. Suitably, the spindle may contact the housing radially, i.e. along its circumference, at its two axial ends. For example, the housing may have at least one tubular portion in which the spindle is mounted axially displaceably, in particular slidingly. The spindle may radially contact an inside of the tubular portion. Such a tubular configuration allows a good seal using standard sealing rings. In principle however, other configurations are conceivable e.g. polygonal, flattened and/or grooved, in order to achieve protection against twisting. In this case, a seal may also be achieved by bellows. In any case, on an axial movement of the spindle relative to the housing, the regions in which the spindle rests on the housing may migrate.

Direct radial support of the spindle on the housing can significantly reduce the installation space required by the linear actuator. In contrast to conventional linear actuators with a linear unit, in which the spindle is usually indirectly guided through two opposing openings in the housing by thrust tubes or push-rods, the travel of the spindle can be extended thanks to the direct radial support on the housing. Accordingly, a greater travel-length ratio can be achieved.

Preferred embodiments of the invention and their refinements are described below. These embodiments may, unless expressly excluded, be combined arbitrarily together and with other aspects of the invention described below.

In a preferred embodiment, the linear unit is configured as a ball screw drive. In comparison with conventional screw gears, in this way friction and wear can be reduced, and the slip-stick behavior improved.

Alternatively however, it is also conceivable to configure the linear unit as a roller screw drive, in particular a planetary roller screw drive or sliding spindle. In this way, high load factors can be achieved.

In a further preferred embodiment, the spindle is disposed completely in the housing, in particular in every axial position, i.e. at all times. In particular, the linear actuator has no component rigidly connected to the spindle which moves out of or into the housing on an axial movement of the spindle. For example, no thrust tubes are attached to the axial ends of the spindle to carry the axial movement of the spindle out of the housing. This allows a particularly compact configuration of the linear actuator and a lightweight integration e.g. in steering systems with steering arms.

In a further preferred embodiment, the spindle has a greater diameter at its axial ends than in a portion between the two axial ends. In particular, the spindle may have a greater diameter at its axial ends than in a threaded portion in which the spindle interacts with the spindle nut. Thus the spindle can be reliably axially guided in the housing. For example, the orientation of the spindle in the housing can thus be stabilized.

For example, at each of its axial ends, the spindle may have a support device for radial support on the housing. The support devices are suitably formed substantially cylindrical so that the casing surface can slide along a housing inner wall. Alternatively however, polygonal and/or flattened forms are conceivable in order to achieve twist prevention. To this extent, the support device may also include a groove or a guide rail engaging in a groove of the housing.

In a further preferred embodiment, at each of its axial ends, the spindle has a fixing device for fixing a load transmission device. Using the load transmission device, suitably a movement of the spindle out of the housing can be transmitted to components outside the housing. The fixing devices at the axial ends of the spindle allow the load transmission device to reach compactly into the housing on a corresponding spindle movement.

The fixing devices may for example be configured as fork heads. In this way, the load transmission device can easily be attached or released as required and if necessary replaced.

In a further preferred embodiment, the support devices and/or the fixing devices each include a threaded pin. Suitably, they are thereby screwed into a spindle body. This may simplify mounting of the linear actuator and allows a simple exchange of the support and/or fixing devices, for example in the case of wear.

Alternatively however, it is also conceivable that the support devices and/or the fixing devices and the spindle body are produced integrally, i.e. they form one component (spindle). The support and/or fixing devices may then correspond to support or fixing portions of the spindle. In other words, at each of its axial ends, the spindle may have a support and/or fixing portion in which the spindle rests on the housing or can be connected to a force transmission device.

In a further preferred embodiment, in the region of each of its axial ends, the spindle has a separate sliding portion and a separate sealing portion. In other words, the sliding portion is in each case separate from the sealing portion. This allows an efficient, in particular energy-saving and resource-protecting use of the linear actuator by reducing friction and saving lubricant.

In order to ensure an axial guidance of the spindle, the sliding portions are suitably configured to transmit radial forces from the spindle to the housing or vice versa.

The sealing portions are suitably configured to seal the linear actuator, for example against an escape of lubricant from the housing. In each sealing portion, the spindle suitably has a sealing device, e.g. an O-ring and/or scraper. In order to allow the radial force transmission into the sliding portions, the sealing device is preferably deformable.

In order to further reduce the friction upon an axial spindle movement, preferably at least two circumferentially running sliding guide strips are disposed next to one another in each sliding portion. These sliding guide strips may for example be made of polyoxymethylene (POM). Through the use of two such strips, the function of the sliding portion can be maintained even if one strip fails, e.g. due to fatigue breakage.

In a further preferred embodiment, at each of its axial ends, the spindle has at least one contact face for limiting the travel of the spindle, i.e. the adjustment travel. With these contact faces, the axial ends can meet a corresponding stop face in order to suppress a further axial movement of the spindle. Using such contact faces, the maximum permitted travel of the spindle, for example relative to the housing, can be set particularly precisely and reliably.

It is for example conceivable that the two contact faces face one another and are configured for blocking a spindle nut of the linear unit. With such contact faces, the spindle can be prevented from undesirably being moved through the spindle nut.

Alternatively or additionally, the two contact faces may face away from one another. In this case, the housing suitably has a protrusion at each of two mutually opposing axial ends. The two contact faces may be configured for striking the protrusions. With such contact faces, the spindle can be prevented from undesirably being moved out of the housing through the openings.

The protrusions suitably form openings in the housing through which the spindle can be contacted, for example connected to a force transmission device, from outside the housing.

In a further preferred embodiment, the housing has two mutually opposing axial openings through which a force transmission device can be introduced into the housing for coupling to a respective one of the axial ends of the spindle. In other words, through the openings, the spindle can be contacted from outside the housing, for example connected to the force transmission device.

The openings are suitably formed by the protrusions, in particular limited thereby. In this way, dedicated components for limiting the travel can be omitted.

In a further preferred embodiment, the linear actuator is preferably configured as a double-action linear actuator. In particular, the spindle may be configured as a double-action spindle. The term “double-action” in this case means acting at both ends. In other words, the linear actuator or the spindle may act, e.g. exert a force, at two opposite ends.

In a further preferred embodiment, at each of its axial ends the spindle has a twist-prevention device cooperating with the housing. For example, the axial ends are formed angular, e.g. rectangular or polygonal, or flattened or oval. Alternatively or additionally, one or both ends may have a groove or guide rail. The housing is suitably formed in complementary fashion, in particular in the region of a housing inner wall which guides the axial movement of the spindle and absorbs transverse loads. The twist-prevention device may prevent transmission of the drive moment, acting on the spindle, to axles of a steering system for example.

With the objects of the invention in view, there is concomitantly provided, according to a second aspect of the invention, a steering system which may be configured as a double-pivot steering system. In the steering system, two track rods are suitably connected to a spindle of a linear actuator according to the first aspect of the invention. In this way, the track rods may be positioned precisely and at the same time moved along a long adjustment travel. Such a steering system may be configured compactly and be operated without hydraulic fluid or oil.

The invention is explained in more detail below with reference to the figures. Where appropriate, elements with similar function carry the same reference signs. The invention is not restricted to the exemplary embodiments shown in the figures, nor in relation to functional features. The above description and the following description of the figures contain numerous features which are partly combined in the dependent subclaims. These features, and all other features disclosed above and in the following description of the figures, may be considered individually by the person skilled in the art or combined into suitable further combinations. In particular, all of the features may be used individually and in any suitable combination with the linear actuator according to the first aspect of the invention and the steering system according to the second aspect of the invention.

Other features which are considered as characteristic for the invention are set forth in the appended claims.

Although the invention is illustrated and described herein as embodied in a linear actuator and a steering system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, plan view of an example of a linear actuator from the prior art;

FIG. 2 is a plan view of an example of a linear actuator with a spindle which is supported radially on a housing at its two axial ends;

FIG. 3 is a plan view of an example of an axial end of a spindle; and

FIG. 4 is a plan view of an example of a steering system.

### DETAILED DESCRIPTION OF THE INVENTION

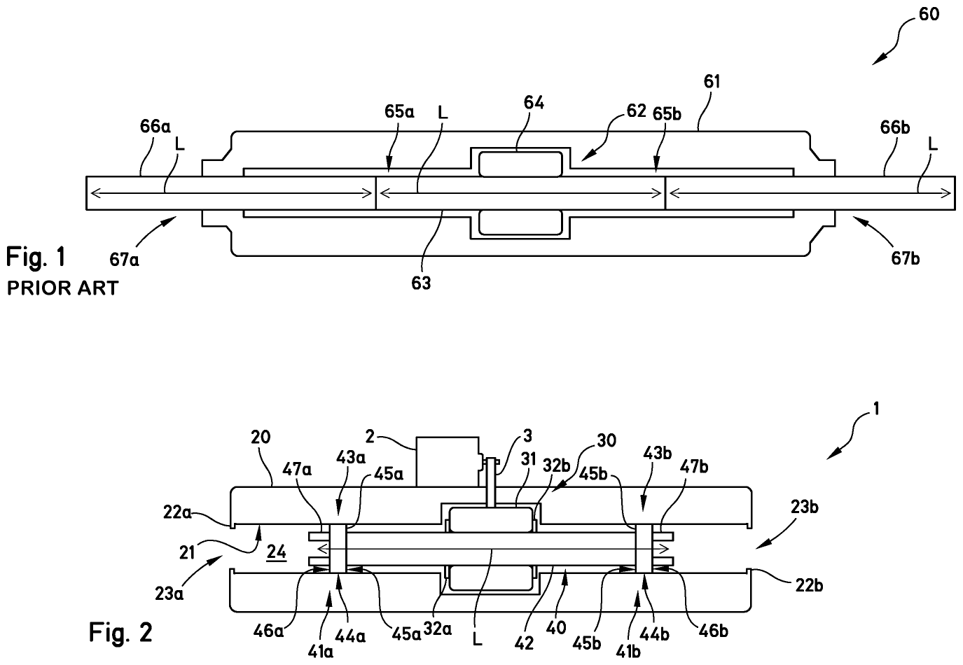

Referring now to the figures of the drawings in detail and first, particularly, to FIG. 1 thereof, there is seen an example of a linear actuator 60 from the prior art. The linear actuator 60 has a housing 61 and a linear unit 62 disposed therein, with a spindle 63 and a spindle nut 64. Thrust tubes 66a, 66b are attached at axial ends 65a, 65b of the spindle 63, through which an axial movement of the spindle 63 is conducted outside the housing 61. For this purpose, the thrust tubes 66a, 66b protrude from the housing 61 on both sides through openings 67a, 67b.

The spindle 63 is supported radially on the housing 61 by the thrust tubes 66a, 66b, i.e. indirectly. In particular, the spindle 63 is radially supported by the thrust tubes 66a, 66b at the point where they contact the housing in the region of the opening 67a, 67b.

The spindle 63 and the thrust tubes 66a, 66b in this case each have substantially the same length L. The housing 61 has substantially twice the length 2L of the spindle 63 or the thrust tubes 66a, 66b. Thus, one of the thrust tubes 66a, 66b can be moved almost completely out of the housing 61, while the other of the thrust tubes 66b, 66a disappears substantially completely into the housing 61. The total length of the linear actuator 60 is therefore always around 3L (in some cases, the spindle 63 is configured slightly longer in order to take account of the axial extension of the spindle nut 64). Accordingly, the travel-length ratio is around L/3L=⅓.

FIG. 2 shows an example of a linear actuator 1 with a housing 20 and a linear unit 30 disposed in the housing 20. The linear unit 30 has a spindle 40 and a spindle nut 31 which can be driven by a motor 2. A drive connection between the motor 2 and the spindle nut 31 may be provided by a gear mechanism 3, in particular one or more toothed belts, spur gears, bevel gears, conical gears, worm gears, hypoids and/or similar, in particular a combination thereof. The spindle 40 is mounted axially displaceably in the housing 20 and is supported radially, i.e. perpendicularly to its movement direction, on the housing 20 by its two axial ends 41a, 41b.

To this end, the spindle 40 includes not only a spindle body 42 but preferably also two support devices 43a, 43b. A support device 43a, 43b is disposed at each of the two axial ends 41a, 41b. The support devices 43a, 43b are preferably cylindrical and have a greater circumference than the spindle body 42. Suitably, circumferential faces 44a, 44b of the support devices 43a, 43b with the housing 20 lie slidingly on a correspondingly formed housing inner face 21. The housing inner face 21 may be formed by at least one tubular housing portion which is suitably configured as a passage bore 24 through the housing 20.

In order to limit the travel of the spindle 40, the support devices 43a, 43b preferably have mutually facing contact faces 45a, 45b which are configured to block the spindle nut 31. In particular, the spindle nut 31 may have stop protrusions 32a, 32b which may stop against the contact faces 45a, 45b.

In addition, the support devices 43a, 43b in the present example have optional contact faces 46a, 46b facing away from one another which are configured to striking corresponding protrusions 22a, 22b of the housing 20. The protrusions 22a, 22b in this case suitably form end protrusions on the housing inner face 21. To this extent, the passage bore 24 in the housing 20 may taper at its ends so that the spindle 40, in particular the support devices 43a, 43b, cannot be moved out of the corresponding openings 23a, 23b of the housing 20.

The openings 23a, 23b are preferably configured, in particular disposed, at two axially opposing ends of the housing 20, in such a way that a force transmission device (not shown) can reach into the housing 20, i.e. into the passage bore 24, and be connected to an axial end 41a, 41b of the spindle 40. For this purpose, suitably the spindle 40 has two fixing devices 47a, 47b at its ends, for example in the form of fork heads. The fixing devices 47a, 47b are preferably formed integrally with the support devices 43a, 43b.

The spindle 40 has a length L. The housing 20 has substantially the length 2L. The travel of the spindle 40 corresponds substantially to the length L (less the length of the spindle nut 31, which is however negligible). This gives a travel-length ratio of L/2L=½. This is significantly better than the travel-length ratio of conventional linear actuators with linear units (see FIG. 1).

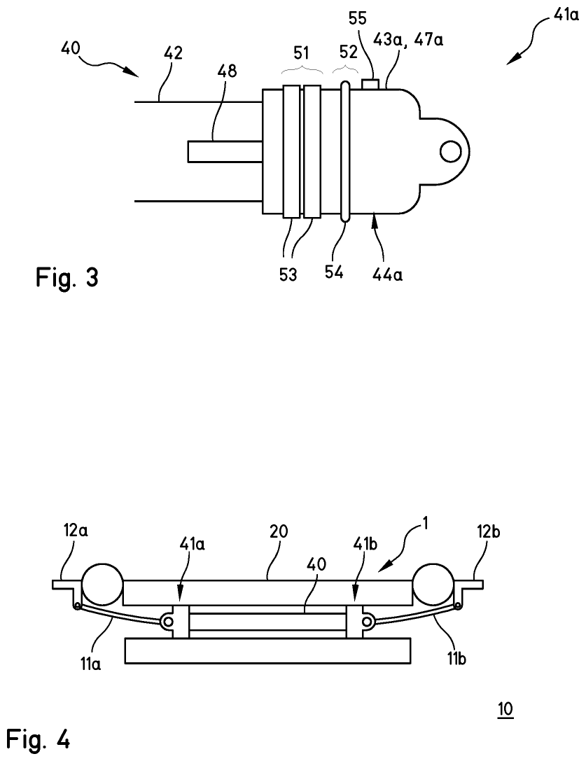

FIG. 3 shows an example of an axial end 41a of a spindle 40 which is configured for radial support on a housing (not shown). The axial end 41a is formed by a support device 43a which at the same time serves as the fixing device 47a. The support device 43a is attached to the end of a spindle body 42 which, on a circumferential face, has a thread for interaction with the corresponding spindle nut.

In the present example, the support device 43a includes a threaded pin 48 for fixing to the spindle body 42, through which pin the support device 43a is or can be screwed into the spindle body 42. Suitably, the spindle body 42 has at its end a corresponding blind hole with an internal thread. Alternatively, the support device 43a is formed integrally with the spindle body 42, i.e. the spindle 40 is made of one piece.

Preferably, a sliding portion 51 and a sealing portion 52 are provided at the axial end 41a of the spindle 40. The sliding portion 51 is suitably formed by two slide guiding strips 53, for example two POM rings. The sealing portion 52 is suitably formed by an annular sealing device 54, for example an O-ring. The slide guiding strips 53 and the annular sealing device 54 preferably sit on a circumferential face 44a of the support device 43a.

FIG. 4 shows an example of a steering system 10 which in the present case is configured as a double-pivot steering system. The steering system 10 has two track rods 11a, 11b which are connected to a spindle 40 of a linear actuator 1. In particular, the track rods 11a, 11b (which serve as a force transmission device) are each attached to a respective axial end 41a, 41b of the spindle 40. Thus, the track rods 11a, 11b may reach into the housing 20 of the linear actuator 1 on which the spindle 40 is radially supported.

Upon axial movement of the spindle 40 in the housing 20, the track rods 11a, 11b move accordingly and through this movement may cause a pivoting of stub axles 12a, 12b which are mounted pivotably relative to the housing 20.

The following is a summary list of reference numerals and the corresponding structure used in the above description of the invention.

### LIST OF REFERENCE SIGNS

1 Linear actuator
2 Motor
3 Gear mechanism
10 Steering system
11a, 11b Track rod
12a, 12b Stub axle
20 Housing
21 Housing inner wall
22a, 22b Protrusion
23a, 23b Opening
24 Passage bore
30 Linear unit
31 Spindle nut
32a, 32b Stop protrusions
40 Spindle
41a, 41b End
42 Spindle body
43a, 43b Support device
44a, 44b Circumferential face
45a, 45b Contact face
46a, 46b Contact face
47a, 47b Fixing device
48 Threaded pin
51 Sliding portion
52 Sealing portion
53 Sliding guide strip
54 Sealing device
60 Linear actuator
61 Housing
62 Linear unit
63 Spindle
64 Spindle nut
65a, 65b End
66a, 66b Thrust tube
67a, 67b Opening
L Length

1. A linear actuator or a steering system linear actuator, comprising:
a housing; and
a linear unit disposed in said housing;
said linear unit having a spindle being axially displaceable in said housing;
said spindle having two axial ends; and
said spindle being radially supported on said housing at said two axial ends.

2. The linear actuator according to claim 1, wherein said spindle has axial positions, and said spindle is disposed completely in said housing in all of said axial positions.

3. The linear actuator according to claim 1, wherein said spindle has a portion between said two axial ends, and said spindle has a greater diameter at said two axial ends than in said portion between said two axial ends.

4. The linear actuator according to claim 1, wherein said spindle has support devices each disposed at a respective one of said two axial ends for radial support on said housing.

5. The linear actuator according to claim 1, wherein said spindle has fixing devices each disposed at a respective one of said two axial ends for fixing a load transmission device.

6. The linear actuator according to claim 5, wherein said fixing devices are configured as fork heads.

7. The linear actuator according to claim 1, wherein:
said spindle has a spindle body;
said spindle has support devices each disposed at a respective one of said two axial ends for radial support on said housing;
said spindle has fixing devices each disposed at a respective one of said two axial ends for fixing a load transmission device; and
at least one of said support devices or said fixing devices each include a respective threaded pin screwed into said spindle body.

8. The linear actuator according to claim 1, wherein said spindle has separate sliding portions each disposed in a region of a respective one of said two axial ends and separate sealing portions each disposed in said region of a respective one of said two axial ends.

9. The linear actuator according to claim 8, which further comprises at least two circumferentially running sliding guide strips disposed next to one another in each respective one of said sliding portions.

10. The linear actuator according to claim 1, wherein said spindle has at least one contact face (45a, 45b, 46a, 46b) disposed at each respective one of said two axial ends for limiting travel of said spindle.

11. The linear actuator according to claim 10, wherein said linear unit has a spindle nut, and said at least one contact face (45a, 45b, 46a, 46b) includes two contact faces facing one another and being configured for blocking said spindle nut.

12. The linear actuator according to claim 10, wherein:
said housing has two mutually opposing axial ends and protrusions each disposed at a respective one of said two mutually opposing axial ends; and
said two contact faces face away from one another and are configured for striking said protrusions.

13. The linear actuator according to claim 1, wherein said housing has two mutually opposing axial openings through which a load transmission device can be introduced into said housing for coupling to a respective one of said two axial ends of said spindle.

14. The linear actuator according to claim 1, wherein said spindle is configured as a double-action spindle.

15. The linear actuator according to claim 1, wherein said spindle has twist-prevention devices each disposed at a respective one of said two axial ends, said twist-prevention devices cooperating with said housing.

16. A steering system or a double-pivot steering system, comprising two track rods connected to said spindle of the linear actuator according to claim 1.
